(19) United States
(12) Patent Application Publication
(10) Pub. No.: US 2018/0107404 A1
(43) Pub. Date: Apr. 19, 2018

(54) GARBAGE COLLECTION SYSTEM AND PROCESS

(71) Applicant: StorReduce, Sunnyvale, CA (US)

(72) Inventors: Mark Leslie Cox, Christchurch (NZ); Mark Alexander Hugh Emberson, Glebe (AU); Tyler Wayne Power, Canterbury (NZ)

(73) Assignee: StorReduce, Sunnyvale, CA (US)

(21) Appl. No.: 15/825,073

(22) Filed: Nov. 28, 2017

Related U.S. Application Data
(63) Continuation-in-part of application No. 15/673,998, filed on Aug. 10, 2017.
Application No. 15/673,998 is a continuation-in-part of application No. 15/600,641, filed on May 19, 2017.
Application No. 15/600,641 is a continuation-in-part of application No. 15/298,897, filed on Oct. 20, 2016.
(60) Provisional application No. 62/373,328, filed on Aug. 10, 2016.
(60) Provisional application No. 62/249,885, filed on Nov. 2, 2015.
(60) Provisional application No. 62/373,328, filed on Aug. 10, 2016.
(60) Provisional application No. 62/427,353, filed on Nov. 29, 2016.
(60) Provisional application No. 62/591,197, filed on Nov. 28, 2017.

(51) Int. Cl. G06F 3/06; H04L 29/08; G06F 12/02

(52) U.S. Cl. CPC G06F 3/0608; H04L 67/1097; G06F 17/30156; G06F 3/067; G06F 12/0253

(57) ABSTRACT

A garbage collection process for a data deduplication storage system is disclosed. In one implementation, a method is disclosed to perform garbage collection that works effectively across a scale-out cluster and across very large amounts of data. The method includes compacting data in an object store in the scale-out cluster by examining data in a reference map of data blocks in the object store to determine which of the locations within a back-end object in an object store are referenced, and which locations are no longer referenced by a process. The back-end object in an Object Store are altered to remove block data from locations which are no longer referenced, and a hash-to-location table is updated to remove the entries for the removed block data.

### PRIORITY AND RELATED APPLICATIONS

This application claims the benefit of U.S. provisional application No. 62/427,353, filed on Nov. 29, 2016, and U.S. provisional application No. 62/591,197 filed on Nov. 28, 2017; and is Continuation in Part of U.S. patent application Ser. No. 15/600,641, filed on May 19, 2017 which is a continuation in Part of U.S. patent application Ser. No. 15/298,897 filed on Oct. 20, 2016, which claims the benefit of U.S. provisional Application No. 62/249,885, filed on Nov. 2, 2015, U.S. provisional application No. 62/373,328, filed on Aug. 10, 2016, and U.S. provisional application No. 62/339,090, filed on May 20, 2016; the contents of which are hereby incorporated by reference.

### TECHNICAL FIELD

These claimed embodiments relate to a method for reducing storage of data using deduplication and more particularly to performing garbage collection on deduplicated data in a memory of one or more multiple network capable servers.

### BACKGROUND OF THE INVENTION

A garbage collection system using an intermediary networked device to store data objects on a remotely located object storage device(s) is disclosed.

Deduplication is a specialized data compression technique for eliminating duplicate copies of data. Deduplication of data is typically done to decrease the cost of storage of the data using a specially configured storage device having a deduplication engine internally connected directly to a storage drive.

The deduplication engine within the storage device receives data from an external device. The deduplication engine creates a hash from the received data which is stored in a table. The table is scanned to determine if an identical hash was previously stored in the table. If it was not, the received data is stored in the Cloud Object Store, and a location pointer for the received data is stored in an entry within the table along with hash of the received data. When a duplicate of the received data is detected, an entry is stored in the table containing the hash and an index pointing to the location within the Cloud Object Store where the duplicated data is stored.

This system has the deduplication engine directly coupled to an internal storage drive to maintain low latency and fast storage of the hash table. However, the data is stored in a Cloud Object Store.

When an object managed by a deduplication engine is deleted by a client, the storage space used in the Cloud Object Store is not reclaimed immediately. Some blocks of information may be referenced by multiple objects, so only the blocks that are no longer referenced can be physically deleted and have their storage space feed up. The process of discovering blocks that are no longer referenced and freeing up the corresponding storage space is known as garbage collection.

Performing garbage collection in a way that scales up to large amounts of data is one of the most difficult problems for a deduplication engine. This difficulty is compounded by the complexity of spreading the data across a cluster of servers.

### SUMMARY OF THE INVENTION

In one implementation, a method is disclosed to perform garbage collection that works effectively across a system spread over multiple servers (a scale-out cluster) and across very large amounts of data by compacting data in data blocks in an object store. Compacting data in the object store includes storing backend objects in the object store and examining data in a reference map of the object store to determine which of the locations within a back-end object in the object store are referenced in the map, and which locations are no longer referenced. The back-end object in the object store are altered to remove block data from locations which are no longer referenced, and a hash-to-location table is updated to remove the entries for block data that have been removed.

The method describes a series of messages, data structures and data stores that can be used to perform garbage collection for a deduplication system spread across multiple servers in a scale-out cluster.

The method may be a two-phase process—a trace process followed by a compaction process. The trace process determines which locations contain data that is still active or referenced. The compaction process removes data from locations that are no longer referenced.

In another implementation, a system is provided to perform garbage collection to compact data. The system includes an object store storing a backend object and one or more multiple network capable servers including an object store. The system includes circuitry to create a reference map in the object store to indicate which locations within a back-end object stored in the object store are currently referenced, and which locations within the back-end object stored in the object store are no longer referenced. The system includes circuitry to alter the back-end object stored in the object store to remove block data from the locations within the back-end object stored in the object store which are no longer referenced, and circuitry to remove entries within a hash-to-location table identifying locations of block data within the back-end object that have been removed.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a simplified schematic diagram of a deduplication storage system using an intermediary networked device to perform deduplication;

FIG. 2 is a simplified schematic and flow diagram of a storage system in which a client application on a client device communicates through an application program interface (API) directly connected to a cloud object store;

FIG. 3 is a simplified schematic diagram and flow diagram of a deduplication storage system in which a client application communicates via a network to an application program interface (API) at an intermediary computing device which performs deduplication, and then stores data via a network to a cloud object store.

FIG. 3A is a simplified schematic diagram and flow diagram of an alternate deduplication storage system in which a client application communicates via a network to a scale out cluster that include an application program interface (API) at multiple intermediary computing devices which perform deduplication, and then transmit data via a network to be stored in a cloud object store. FIG. 3A also shows how the intermediary computing devices can initiate a garbage collection by exchanging messages.

FIG. 4 is a simplified schematic diagram of an intermediary computing device shown in FIG. 3.

FIG. 5 is a flow chart of a process for storing and deduplicating data executed by the intermediary computing device shown in FIG. 3;

FIG. 6 is a flow diagram illustrating the process for storing and deduplicating data;

FIG. 7 is a flow diagram illustrating the process for storing and deduplicating data executed on the client device of FIG. 3.

FIG. 8 is a data diagram illustrating how data is partitioned into blocks for storage.

FIG. 9 is a data diagram illustrating how the partitioned data blocks are stored in memory.

FIG. 10 is a data diagram illustrating a relation between a hash and the data blocks that are stored in memory.

FIG. 11 is a data diagram illustrating the file or object table which maps file or object names to the location addresses where the files are stored.

FIG. 12 is a data diagram illustrating a garbage collection coordination process for coordinating garbage collection by an arbitrarily selected StorReduce server in FIG. 3A.

FIG. 13 is a data diagram illustrating a trace process for tracing references in each key shard on StorReduce Servers in FIG. 3A.

FIG. 14 is a data diagram illustrating a compaction process for compacting data stored in each block shard on StorReduce Servers in FIG. 3A.

FIG. 15 is a data diagram illustrating a compact data process for compacting data in the cloud object store that provides a more detailed view of the process shown in step 1414 on FIG. 14.

### DETAILED DESCRIPTION

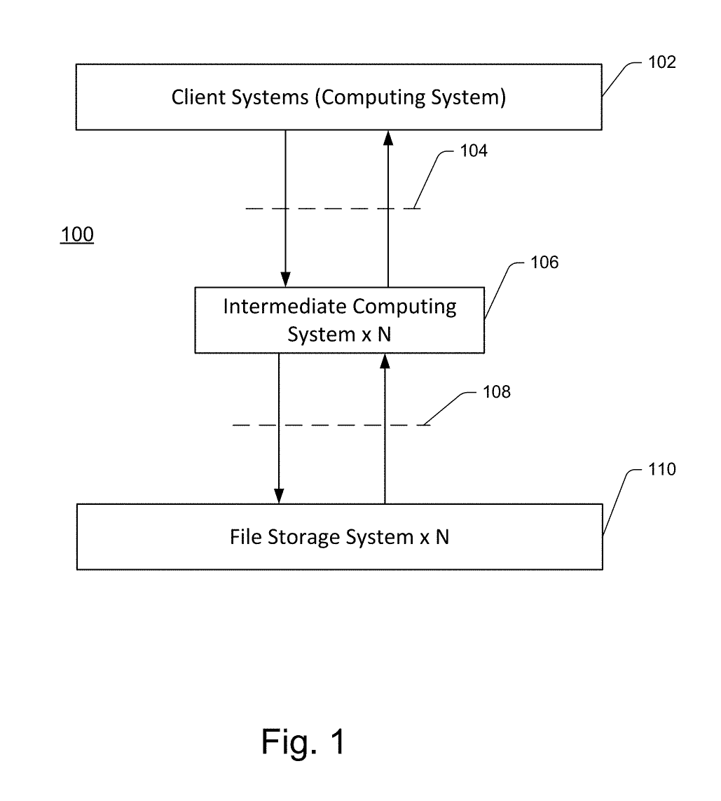

Referring to FIG. 1, there is shown a deduplication storage system 100. Storage system 100 includes a client system 102, coupled via network 104 to Intermediate Computing system 106. Intermediate computing system 106 is coupled via network 108 to remotely located File Storage system 110.

Storage system 100 transmits data objects to intermediate computing system 106 via network 104. Intermediate computing system 106 includes a process for storing the received data objects on file storage system 100 to reduce duplication of the data objects when stored on file system 100.

Storage system 100 transmits requests via network 104 to intermediate computing system 106 for data store on file storage system 110. Intermediate computing system 106 responds to the requests by obtaining the deduplicated data on file system 110, and transmits the obtained data to client system 100.

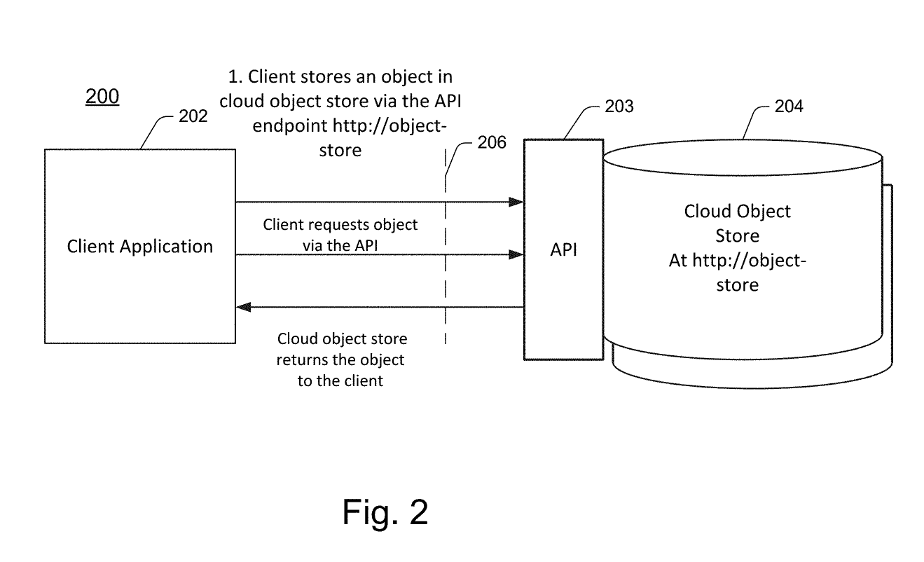

Referring to FIG. 2, a storage system 200 that includes a client application 202 on a client device 204 that communicates via a network 206 through an application program interface (API) 203 directly connected to a cloud object store 204. In one implementation the cloud object store may be a non-transitory memory storage device coupled with a server.

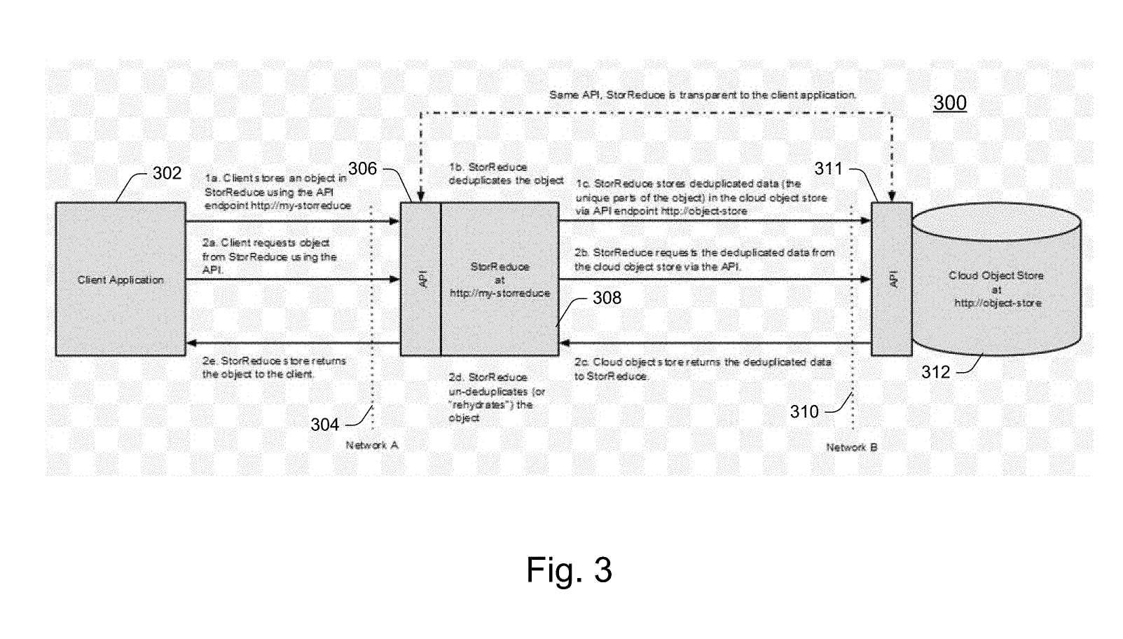

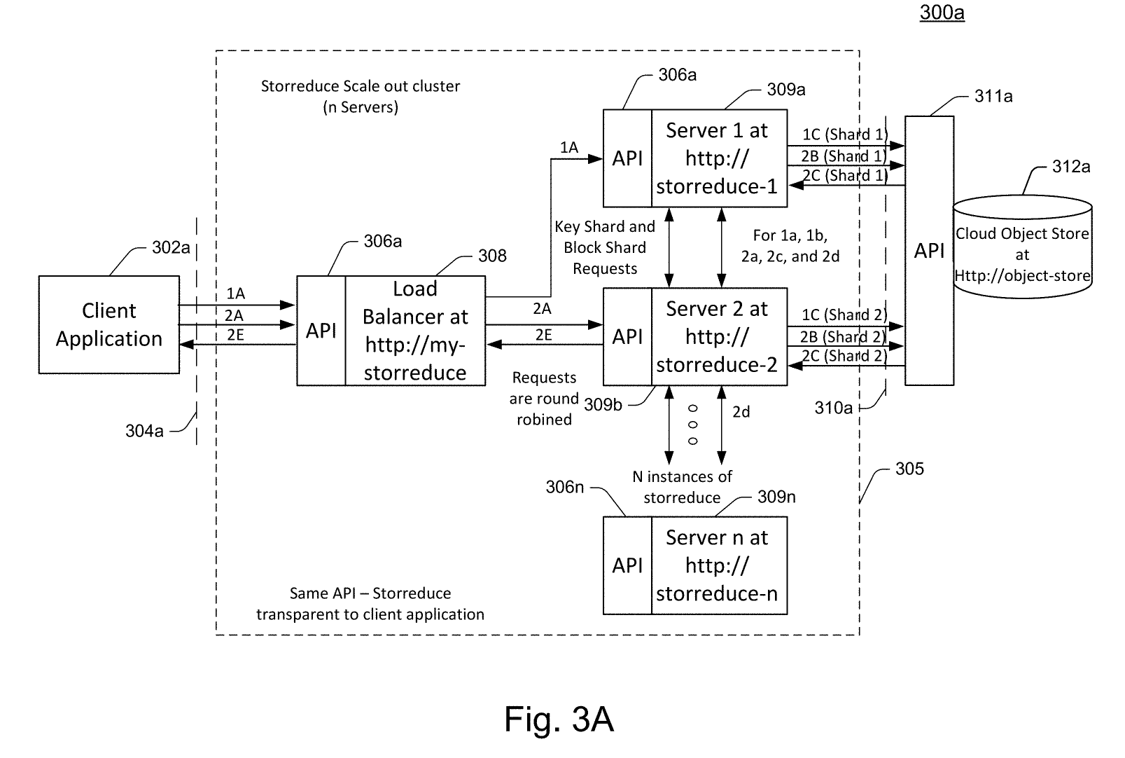

Referring to FIG. 3, there is shown a deduplication storage system 300 including a client application 302 communicates data via a network 304 to an application program interface (API) 311 at an intermediary computing device 308. The data is deduplicated on intermediary computing device 308 and then the unique data is stored via a network 310 and API 311 (API 203 in FIG. 2) on a remotely disposed computing device 312 such as a cloud object store system that may typically be administered by an object store service.

Exemplary Networks 304 and 310 include, but are not limited to, an Ethernet Local Area Network, a Wide Area Network, an Internet Wireless Local Area Network, an 802.11g standard network, a WiFi network, a Wireless Wide Area Network running protocols such as GSM, WiMAX, or LTE.

Examples of the intermediary computing device 308, includes, but is not limited to, a Physical Server, a personal computing device, a Virtual Server, a Virtual Private Server, a Network Appliance, and a Router/Firewall.

Exemplary remotely disposed computing device 312 may include, but is not limited to, a Network Fileserver, an Object Store, an Object Store Service, a Network Attached device, a Web server with or without WebDAV.

Examples of the cloud object store include, but are not limited to, OpenStack Swift, IBM Cloud Object Storage and Cloudian HyperStore. Examples of the object store service include, but are not limited to, Amazon® S3, Microsoft® Azure Blob Service and Google® Cloud Storage.

During operation Client application 302 transmits a file via network 304 for storage by providing an API endpoint (such as http://my-storereduce.com) 306 corresponding to a network address of the intermediary device 308. The intermediary device 308 then deduplicates the file as described herein. The intermediary device 308 then stores the deduplicated data on the remotely disposed computing device 312 via API endpoint 311. In one exemplary implementation, the API endpoint 306 on the intermediary device is virtually identical to the API endpoint 311 on the remotely disposed computing device 312.

If client application need to retrieve a stored data file, client application 302 transmits a request for the file to the API endpoint 306. The intermediary device 308 responds to the request by requesting the deduplicated data from remotely disposed computing device 312 via API endpoint 311. The cloud object store 312 and API endpoint 311 accommodate the request by returning the deduplicated data to the intermediate device 308, that is then un-deduplicated by the intermediate device 308. The intermediate device 308 via API 306 returns the file to client application 302.

In one implementation, device 308 and a cloud object store is present on device 312 that present the same API to the network. In one implementation, the client application 302 uses the same set of operations for storing and retrieving objects. Preferably the intermediate device 307 is almost transparent to the client application. The client application 302 does not need to know that the intermediate API 311 and intermediate device 306 are present. When migrating from a system without the intermediate processing device 308 (as shown in FIG. 2) to a system with the intermediate processing device, the only change for the client application 302 is that location of the endpoint of where it stores data has changed in its configuration (e.g., from http://objectstore to http://mystorreduce). The location of the intermediate processing device can be physically close to the client application to reduce the amount of data crossing Network 310 which can be a low bandwidth Wide Area Network.

Referring to FIG. 3A, there is shown an alternate deduplication storage system 300a including a client application 302a that communicates data via a network 304a to a store reduce scale out cluster 305. Cluster 305 includes an application program interface (API) 306a and a load balancer 308 coupled to server 1 309a through server n 309n. Server 1 309a through server n 309n are coupled to cloud object store 312a via network 310a and API 311a. Computing device 308 may be a load balancer at exemplary network address http://my-storreduce. Servers 309a-309n may be located at exemplary network address http://storreduce-1 through http://storreduce-n.

The data is deduplicated using server 1 309a through server n 309n to determine unique data. The unique data determined from the deduplicating process is stored via a network 310a and API 311a (API 211 in FIG. 2) on a remotely disposed computing device 312a such as a public cloud object store system providing an object store service, or a private object store system.

Exemplary Networks 304a and 310a include, but are not limited to, an Ethernet Local Area Network, a Wide Area Network, an Internet Wireless Local Area Network, an 802.11g standard network, a WiFi network, a Wireless Wide Area Network running protocols such as GSM, WiMAX, or LTE.

Examples of the load balancer 308a and servers 309a-309n include, but are not limited to, a Physical Server, a personal computing device, a Virtual Server, a Virtual Private Server, a Network Appliance, and a Router/Firewall.

Exemplary remotely disposed computing device 312a may include, but is not limited to, a Network Fileserver, an Object Store, an Object Store Service, a Network Attached device, a Web server with or without WebDAV.

Examples of the cloud object store include, but are not limited to, OpenStack Swift, IBM Cloud Object Storage and Cloudian HyperStore. Examples of the object store service include, but are not limited to, Amazon® S3, Microsoft® Azure Blob Storage and Google® Cloud Storage.

During operation, the Client application 302a transmits a file (request 1A) via network 304a for storage by using an API endpoint (such as http://my-storreduce.com) 306a corresponding to a network address of the load balancer 308. The load balancer 308 chooses a server to send the request to and forwards the request (1A), in this case to Server 309a. This Coordinating Server (309a) will split the file into blocks of data and calculate the hash of each block. Each block will be assigned to a shard based on its hash, and each shard is assigned to one of servers 309a-309n. The Coordinating Server will send each block of data to the server (309a to 309n) responsible for that shard, shown as “Key Shard and Block Shard Requests” in the diagram.

Servers 309a-309n each perform deduplication for the blocks of data sent to them as described herein (step 1b), and store the deduplicated data on the remotely disposed computing device 312a via API endpoint 311a (requests “1C (shard 1)” through to “1C (shard n)” on FIG. 3A). In one exemplary implementation, the API endpoint 306a on the intermediary device is virtually identical to the API endpoint 311a on the remotely disposed computing device 312.

Servers 309a-309n each send location information for their Block data back to the Coordinating Server. The Coordinating Server then arranges for this location information to be stored.

If client application need to retrieve a stored data file, client application 302a transmits a request (2A) for the file to the API endpoint 306a. The load balancer 308 chooses a server to send the request to and forwards the request (2A), in this case to Server 309b. This Coordinating Server (309b) will fetch location information for each block in the file, including the shard to which each block of data was assigned.

In one implementation, the Coordinating server will send a request to fetch each block of data to the server (309a to 309n) responsible for that shard, shown as “Key Shard and Block Shard Requests” in the diagram.

Servers 309a-309n respond to the Block shard requests by requesting the deduplicated data from remotely disposed computing device 312a via API endpoint 311a (requests “2B (Shard 1)” through to “2B (Shard n)” on FIG. 3A). The cloud object store 312a and API endpoint 311a accommodate the requests by returning the deduplicated data to servers 309a-309n (responses “2C (shard 1)” through to “2C (shard n)” on FIG. 3A). Servers 309a-309n return the block data to the Coordinating Server (in this case Server 309b).

In an alternative implementation, the Coordinating server will directly fetch each block of data from remotely disposed computing device 312a via API endpoint 311a. The cloud object store 312a and API endpoint 311a accommodate the requests by returning the deduplicated data to the Coordinating server.

The data is then un-deduplicated by the Coordinating Server. The resulting file (2E) is returned to the load balancer (308) which then returns the file via API 306a to client application 302a.

In one implementation, device 309a and the cloud object store on device 312a present the same API to the network. In one implementation, the client application 302a uses the same set of operations for storing and retrieving objects. Preferable the intermediate scale-out cluster 300a is almost transparent to the client application. The client application 302a does not need to know that the intermediate API 306a and intermediate scale-out cluster 300a are present. When migrating from a system without the intermediate scale-out cluster 300a (as shown in FIG. 2) to a system with the intermediate processing device, the only change for the client application 302a is that location of the endpoint of where it stores data has changed in its configuration (e.g., from http://objectstore to http://mystorreduce). The location of the intermediate scale-out cluster 300a can be physically close to the client application to reduce the amount of data crossing Network 310 which can be a low bandwidth Wide Area Network.

The objects being managed by the system 300a each have an object key, and these keys are used to divide the of objects into sets known as key shards. Each key shard is assigned to a server within the cluster, which is then responsible for managing information for each object in that key shard. In particular, information about the set of blocks which make up the data for the object is managed by the key shard server for that object.

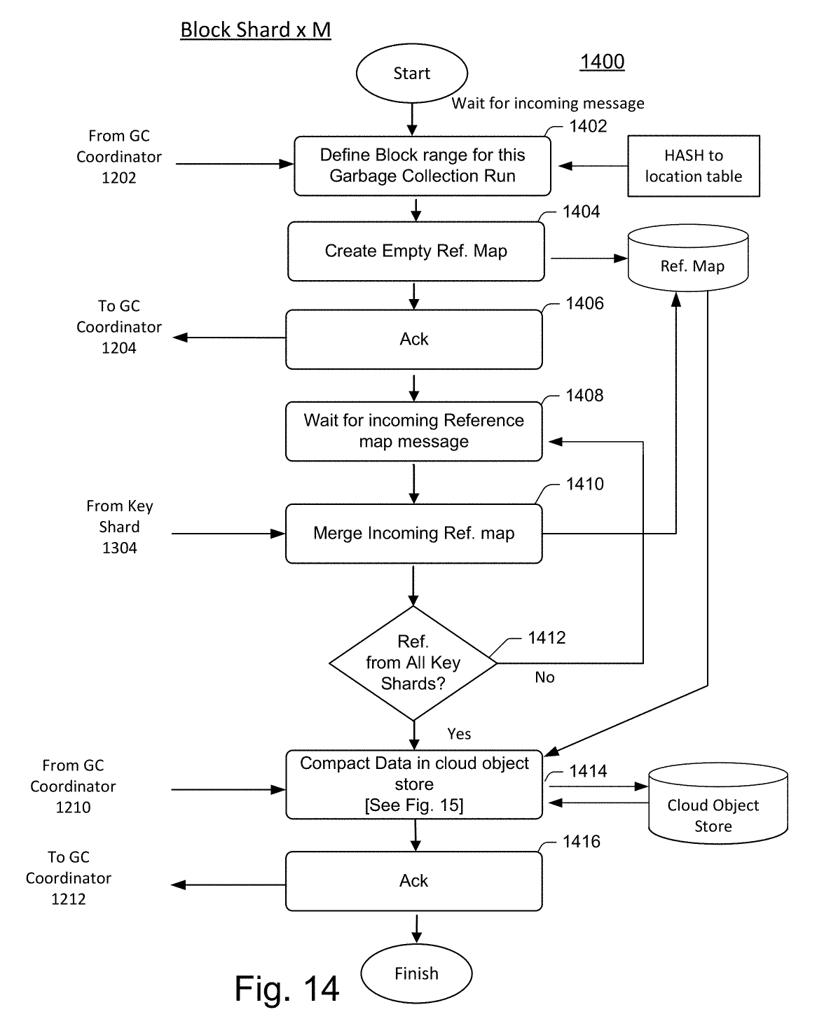

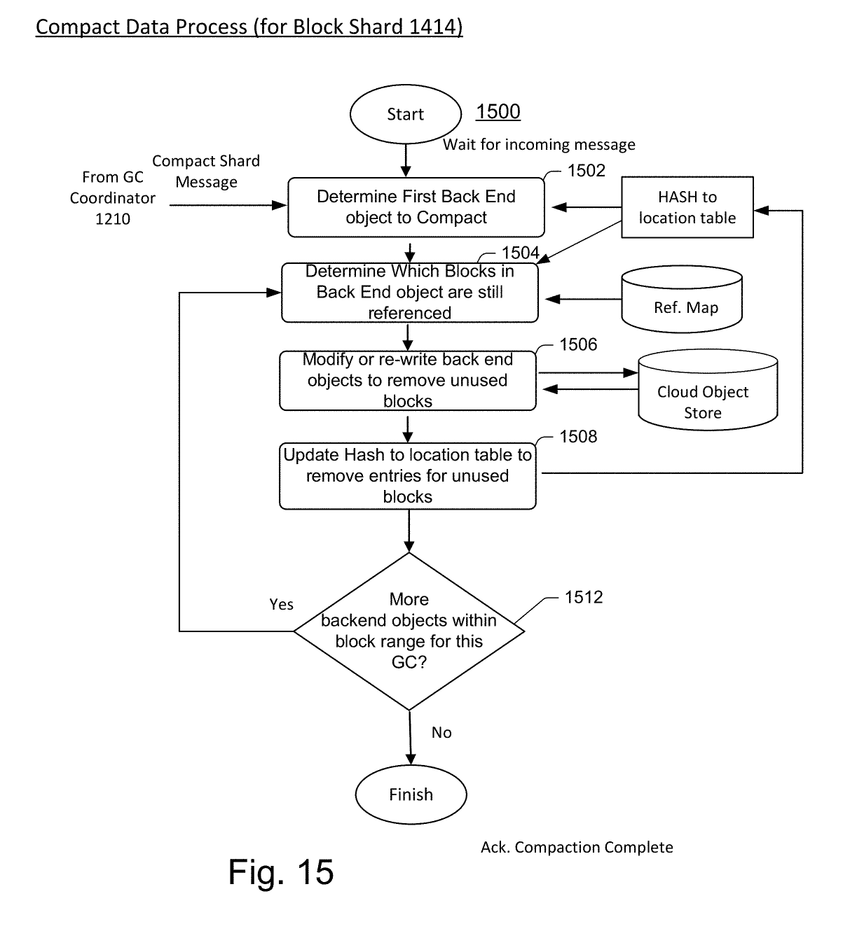

The unique blocks of data being managed by the system 300 are each identified by their hash, using a cryptographic hash algorithm. The hash namespace is divided into subsets known as block shards. Each block shard is assigned to a server within the cluster, which is then responsible for operations on blocks whose hashes fall within that subset of the hash namespace. In particular, the block shard server can answer the question “is this block with this hash new/unique, or do we already have it stored?”. The block shard server is also responsible for storing and retrieving blocks whose hashes fall within its subset of the hash namespace. During garbage collection the block shard server collects and merges the reference maps from every key shard (as described in FIG. 14) and then runs the compaction process (as described in FIG. 15) to remove blocks that are no longer referenced.

Each block shard is responsible for storing blocks into the underlying object store (also known as the ‘cloud object store’). Multiple blocks may be grouped together into an aggregate block in which case all blocks in the aggregate block are stored in a single ‘file’ (object) in the underlying object store.

When writing an object to the system, each block is hashed and sent to the appropriate block shard, which will look up the block hash, store the block data if it is unique, and return a reference to the block. After all blocks are stored, the references are collated from the various block shards. A key is assigned to the object and the corresponding key shard stores the list of references for the blocks making up the object.

When reading an object back from the system, the key is provided by the client and the corresponding key shard supplies the list of references for the blocks making up the object. For each reference the block data is retrieved from the cloud object store. The data for all blocks is then assembled and returned to the client.

When deleting an object, the key is provided by the client, and the corresponding key shard deletes the information held about this object, including the list of references for the blocks making up the object. No changes are made within the block shards for those blocks.

After deletion of an object each block may or may not still be referenced by other objects, so no blocks are deleted at this stage and no storage space is reclaimed—this is the purpose of the garbage collection process. Deleting an object simply removes that object's references to its data blocks from the key shard for the object.

### Example Computing Device Architecture

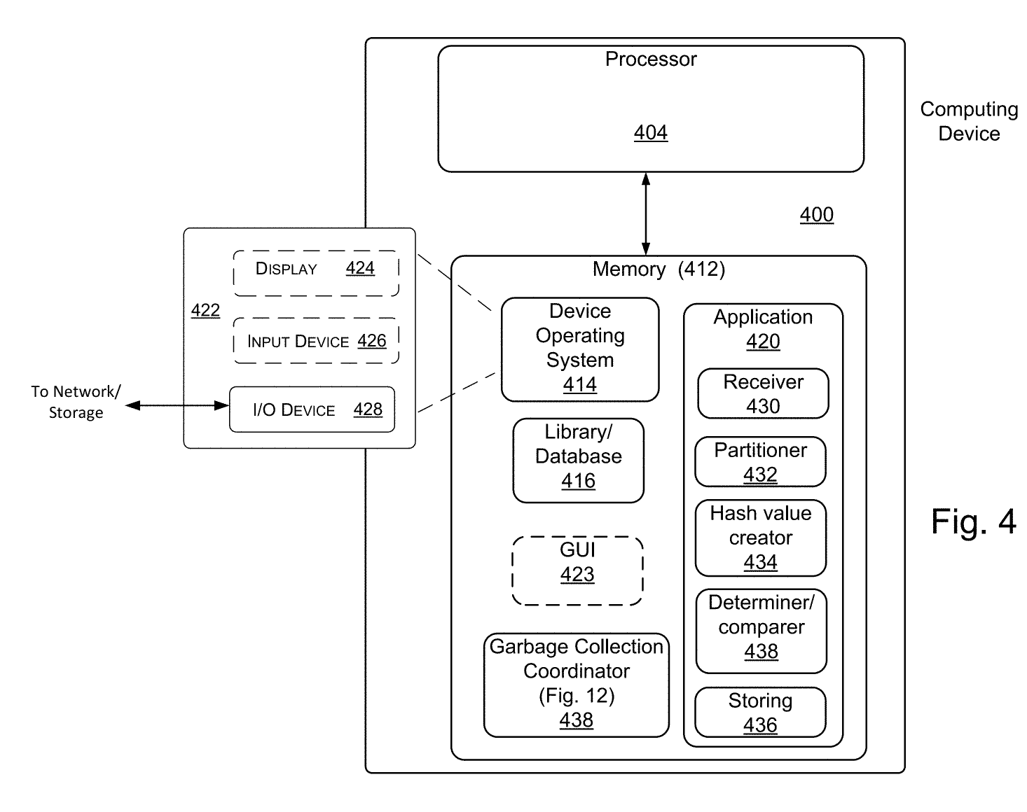

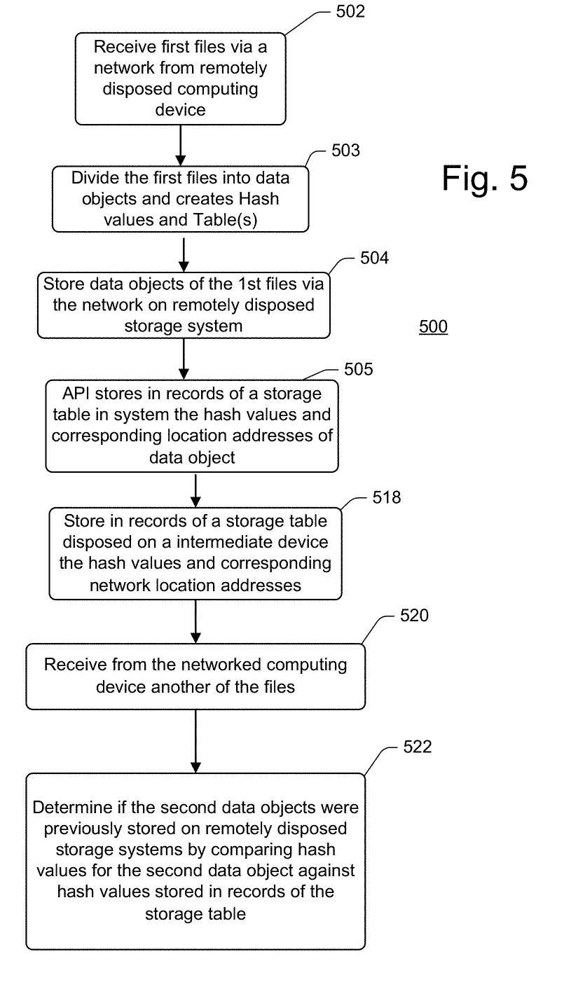

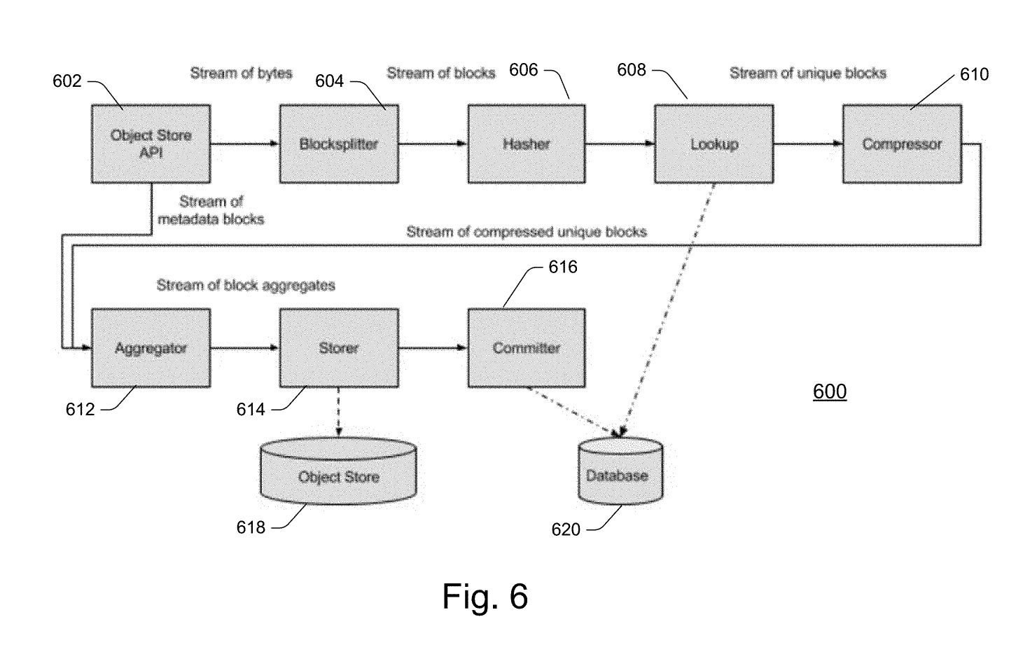

In FIG. 4 are illustrated selected modules in computing device 400 using processes 500 and 600 shown in FIGS. 5-6 respectively to store and retrieve deduplicated data objects. Computing device 400 (such as intermediary computing device 308 shown in FIG. 3 and the intermediary computing devices 309a-n shown in FIG. 3A) includes a processing device 404 and memory 412. Computing device 400 may include one or more microprocessors, microcontrollers or any such devices for accessing memory 412 (also referred to as a non-transitory media) and hardware 422. Computing device 400 has processing capabilities and memory suitable to store and execute computer-executable instructions.

Computing device 400 executes instruction stored in memory 412, and in response thereto, processes signals from hardware 422. Hardware 422 may include an optional display 424, an optional input device 426 and an I/O communications device 428. I/O communications device 428 may include a network and communication circuitry for communicating with network 304, 310 or an external memory storage device.

Optional Input device 426 receives inputs from a user of the computing device 400 and may include a keyboard, mouse, track pad, microphone, audio input device, video input device, or touch screen display. Optional display device 424 may include an LED, LCD, CRT or any type of display device to enable the user to preview information being stored or processed by computing device 404.

Memory 412 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information, and which can be accessed by a computer system.

Stored in memory 412 of the computing device 400 may include an operating system 414, a deduplication system application 420 and a library of other applications or database 416. Operating system 414 may be used by application 420 to control hardware and various software components within computing device 400. The operating system 414 may include drivers for device 400 to communicate with I/O communications device 428. A database or library 418 may include preconfigured parameters (or set by the user before or after initial operation) such server operating parameters, server libraries, HTML libraries, API's and configurations. An optional graphic user interface or command line interface 423 may be provided to enable application 420 to communicate with display 424.

Application 420 includes a receiver module 430, a partitioner module 432, a hash value creator module 434, determiner/comparer module 438 and a storing module 436.

The receiver module 430 includes instructions to receive one or more files via the network 304 from the remotely disposed computing device 302. The partitioner module 432 includes instructions to partition the one or more received files into one or more data objects. The hash value creator module 434 includes instructions to create one or more hash values for the one or more data objects. Exemplary algorithms to create hash values include, but is not limited to, MD2, MD4, MD5, SHA1, SHA2, SHA3, RIPEMD, WHIRLPOOL, SKEIN, Buzhash, Cyclic Redundancy Checks (CRCs), CRC32, CRC64, and Adler-32.

The determiner/comparer module 438 includes instructions to determine, in response to a receipt from a networked computing device (e.g. device hosting application 302) of one of the one or more additional files that include one or more data objects, if the one or more data objects are identical to one or more data objects previously stored on the one or more remotely disposed storage systems (e.g. device 312) by comparing one or more hash values for the one or more data objects against one or more hash values stored in one or more records of the storage table.

The storing module 436 includes instructions to store the one or more data objects on one or more remotely disposed storage systems (such as remotely disposed computing device 312 using API 311) at one or more location addresses, and instructions to store in one or more records of a storage table, for each of the one or more data objects, the one or more hash values and a corresponding one or more location addresses. The storing module also includes instructions to store in one or more records of the storage table for each of the received one or more data objects if the one or more data objects are identical to one or more data objects previously stored on the one or more remotely disposed storage systems (e.g. device 312), the one or more hash values and a corresponding one or more location addresses of the received one or more data objects, without storing on the one or more remotely disposed storage systems (device 312) the received one or more data objects identical to the previously stored one or more data objects.

Illustrated in FIGS. 5 and 6, are exemplary processes 500 and 600 for deduplicating storage across a network. Such exemplary processes 500 and 600 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 4, although it may be implemented in other system architectures.

Referring to FIG. 5, a flowchart of process 500 executed by a deduplication application 420 (See FIG. 4) (hereafter also referred to as “application 420”) is shown. In one implementation, process 400 is executed in a computing device, such as intermediate computing device 308 (FIG. 3). Application 420, when executed by the processing devices, uses the processor 404 and modules 416-438 shown in FIG. 4.

In block 502, application 420 in computing device 308 receives one or more files via network 304 from a remotely disposed computing device (e.g. device hosting application 302).

In block 503, application 420 divides the received files into data objects, creates hash values for the data objects or portions thereof, and stores the hash values into a storage table in memory on intermediate computing device (e.g. an external computing device, or system 312).

In block 504, application 420 stores the one or more files via the network 310 onto a remotely disposed storage system 312 via API 311.

In block 505, optionally an API within system 312 stores within records of the storage table disposed on system 312 the hash values and corresponding location addresses identifying a network location within system 312 where the data object is stored.

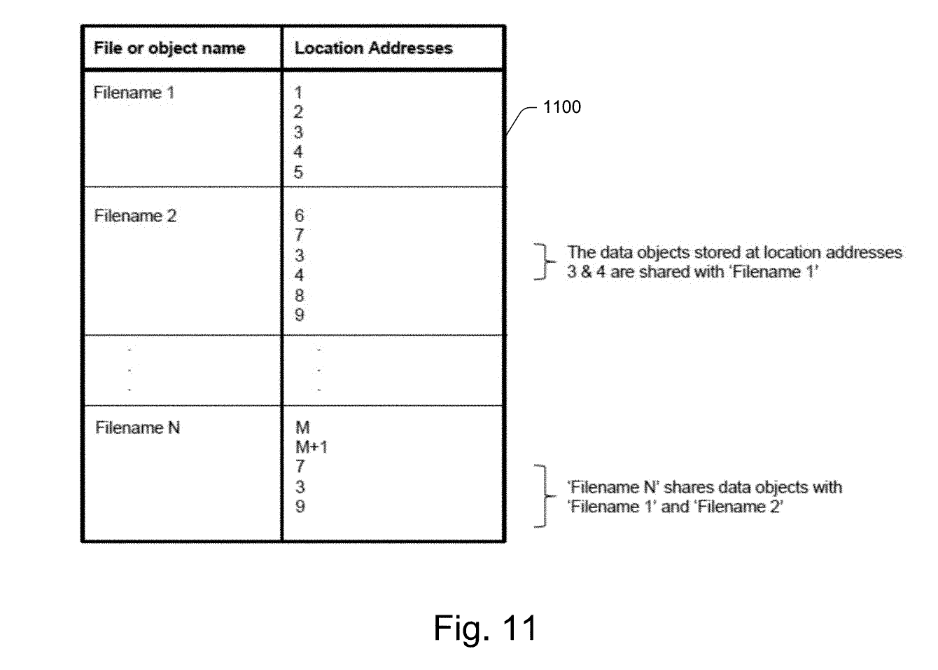

In block 518, application 420 stores in one or more records of a storage table disposed on the intermediate device 308 or a secondary remote storage system (not shown) for each of the one or more data objects the one or more hash values and a corresponding one or more network location addresses. Application 420 also stores in a file table (FIG. 11) the names of the files received at in block 502 and the location addresses created at block 505.

In one implementation, the one or more records of a storage table are stored for each of the one or more data objects the one or more hash values and a corresponding one or more location addresses of the data object without storage of an identical data object on the one or more remotely disposed storage systems. In another implementation, the one or more hash values are transmitted to the remotely disposed storage systems for storage with the one or more data objects. The hash value and a corresponding one or more new location addresses may be stored in the one or more records of the storage table. Also the one or more data objects may be stored on one or more remotely disposed storage systems at one or more location addresses with the one or more hash values.

In block 520, application 420 receive from the networked computing device another of the one or more files.

In block 522, in response to the receipt from a networked computing device of another of the one or more files including one or more data objects, application 420 determine if the one or more data objects were previously stored on one or more remotely disposed storage systems 312 by comparing one or more hash values for the data object against one or more hash values stored in one or more records of the storage table.

In one implementation, the application 420 may deduplicate data objects previously stored on any storage system by including instructions that read one or more files a stored on the remotely disposed storage system, divide the one or more files into one or more data objects, and create one or more hash values for the one or more file data objects. Once the hash values are created, application 420 may store the one or more data objects on one or more remotely disposed storage systems at one or more location addresses, store in one or more records of the storage table, for each of the one or more data objects, the one or more hash values and a corresponding one or more location addresses, and in response to the receipt from the networked computing device of the another of the one or more files including the one or more data objects, determine if the one or more data objects were previously stored on one or more remotely disposed storage systems by comparing one or more hash values for the data object against one or more hash values stored in one or more records of the storage table. The filenames of the files are stored in the file table (FIG. 11) along with the location addresses of the duplicate data objects (from the first files) and the location addresses of the unique data objects from the files.

Referring to FIG. 6, there is shown an alternate embodiment of system architecture diagram illustrating a process 600 for storing data objects with deduplication. Process 600 may be implemented using an application 420 in intermediate computing device 308 shown in FIG. 3.

In block 602, the process includes an application (such as application 420) that receives a request to store an object (e.g., a file) from a client (e.g., the “Client System” in FIG. 1). The request typically consists of an object key (e.g., like a filename), the object data (a stream of bytes) and some metadata.

In block 604, the application splits that the stream of data into blocks, using a block splitting algorithm. In one implementation, the block splitting algorithm could generate variable length blocks like the algorithm described in U.S. Pat. No. 5,990,810 (which is hereby incorporated by reference) or, could generate fixed length blocks of a predetermined size, or could use some other algorithm that produces blocks that have a high probability of matching already stored blocks. When a block boundary is found in the data stream, a block is emitted to the next stage. The block could be almost any size.

In block 606, each block is hashed using a cryptographic hash algorithm like MD5, SHA1 or SHA2 (or one of the other algorithms previously mentioned). Preferably, the constraint is that there must be a very low probability that the hashes of different blocks are the same.

In block 608, each data block hash is looked up in a table mapping block hashes that have already been encountered to data block locations in the cloud object store (e.g. a hash-to-location table). If the hash is found, then that block location is recorded, the data block is discarded and block 616 is run. If the hash is not found in the table, then the data block is compressed in block 610 using a lossless text compression algorithm (e.g., algorithms described in Deflate U.S. Pat. No. 5,051,745, or LZW U.S. Pat. No. 4,558,302, the contents of which are hereby incorporated by reference).

In block 612, the data blocks are optionally aggregated into a sequence of larger aggregated data blocks to enable efficient storage. In block 614, the blocks (or aggregate blocks) are then stored into the underlying object store 618 (the “cloud object store” 312 in FIG. 3). When stored, the data blocks are ordered by naming them with monotonically increasing numbers in the object store 618.

In block 616, after the data blocks are stored in the cloud object store 618, the hash-to-location table is updated, adding the hash of each block and its location in the cloud object store 618.

The hash-to-location table (referenced here and in block 608) is stored in a database (e.g. database 620) that is in turn stored in fast, unreliable, storage directly attached to the computer receiving the request. The block location takes the form of either the number of the aggregate block stored in block 614, the offset of the block in the aggregate, and the length of the block; or, the number of the block stored in block 614.

In block 616, the list of network locations from blocks 608-614 may be stored in the object-key-to-location table (FIG. 11), in fast, unreliable, storage directly attached to the computer receiving the request. Preferably the object key and block locations are stored into the cloud object store 618 using the same monotonically increasing naming scheme as the block records. Each file sent to the system is identified by an Object Key. For each file, the Object-Key-to-Location table contains a list of locations for the blocks making up the file. Each of these Locations is known as a ‘reference’ to the corresponding block. The hash-to-location table is independent of the object-key-to-location table. It contains an entry for every block stored in the system, regardless of whether it is referenced in the object-key-to-location table.

The process may then revert to block 602, in which a response is transmitted to the client device (mentioned in block 602) indicating that the data object has been stored.

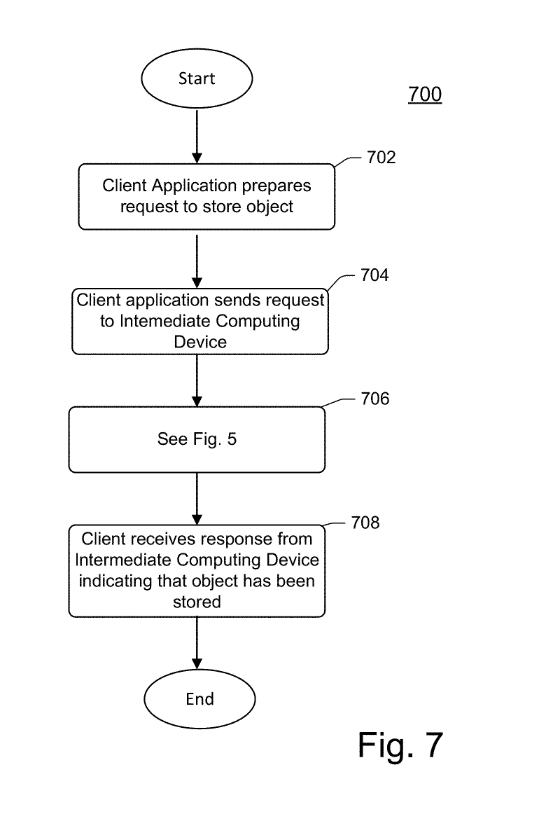

Illustrated in FIG. 7, is exemplary process 700 implemented by the client application 302 (See FIG. 3) for deduplicating storage across a network. Such exemplary process 700 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process is described with reference to FIG. 3, although it may be implemented in other system architectures.

In block 702, client application 302 prepares a request for transmission to intermediate computing device 308 to store a data object. In block 704, client application 302 transmits the data object to intermediate computing device 308 to store a data object.

In block 706, process 500 or 600 is executed by device 308 to store the data object.

In block 708, the client application receives a response notification from the intermediate computing system indicating the data object has been stored.

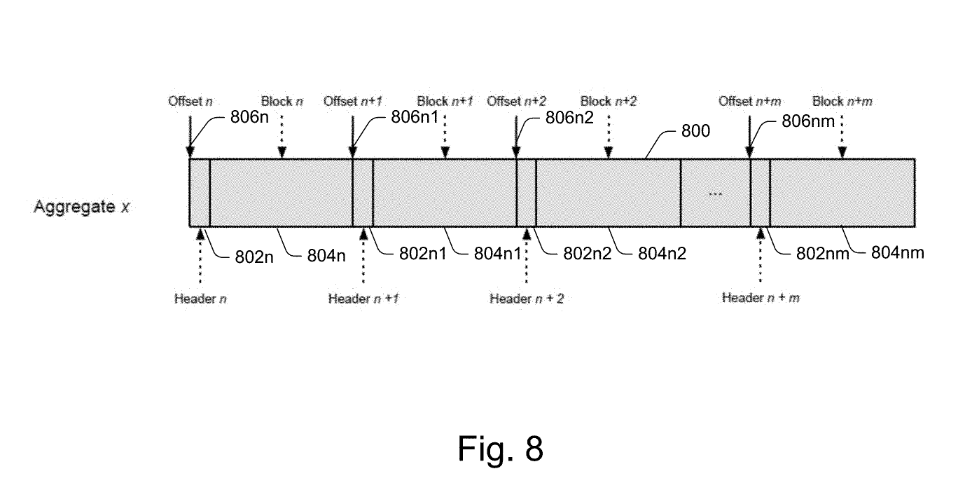

Referring to FIG. 8, an exemplary aggregate data object 800 as produced by block 612 is shown. The data object includes a header 802n-802nm, with a block number 804n-804nm and an offset indication 806n-806nm, and includes a data block.

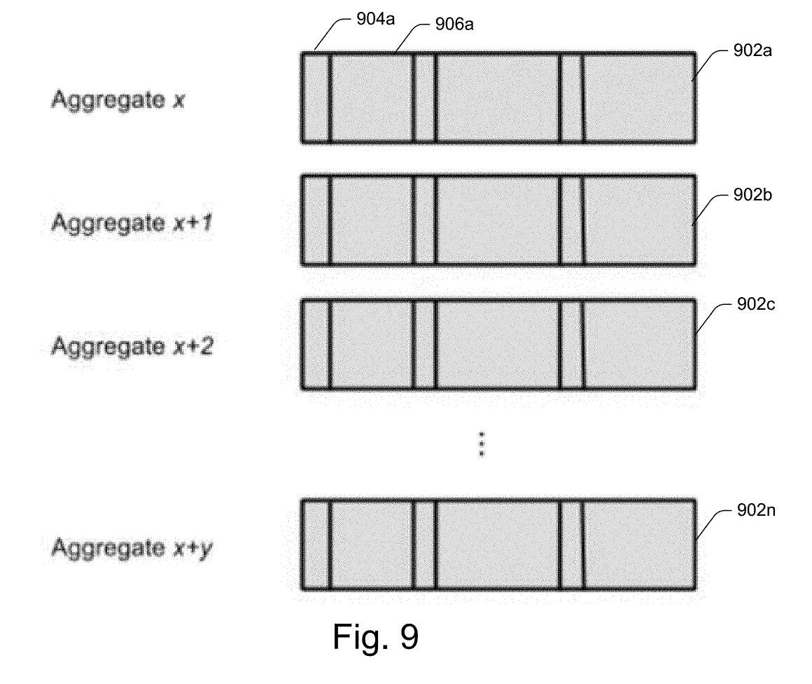

Referring to FIG. 9, an exemplary set of aggregate data objects 902a-902n for storage in memory is shown. The data objects 902a-902n each include the header (e.g. 904a) (as described in connection with FIG. 8) and a data block (e.g. 906a).

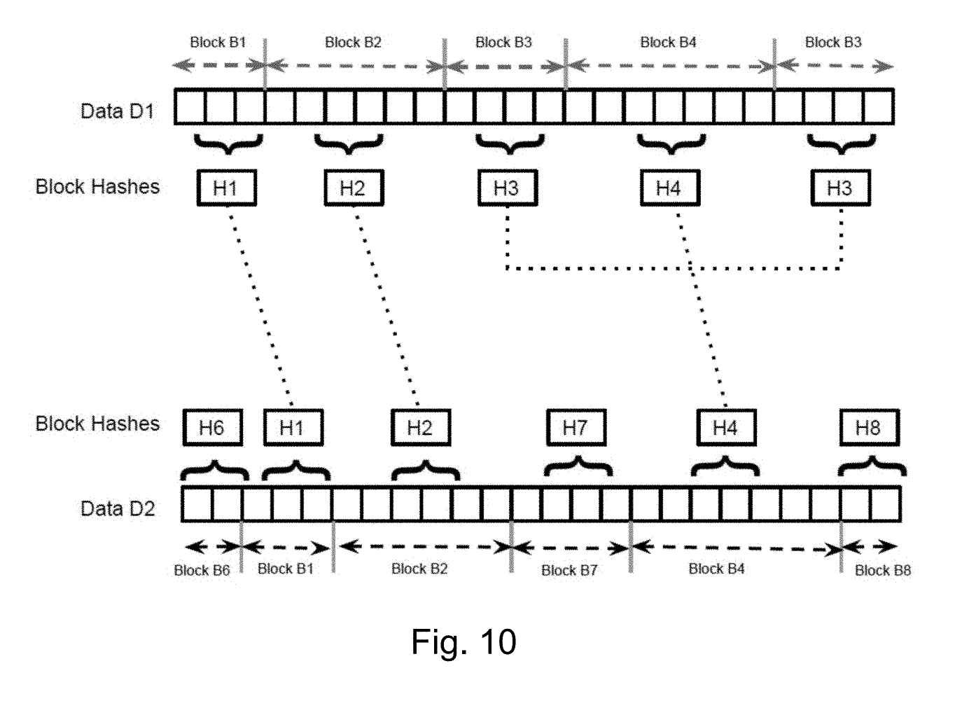

Referring to FIG. 10, an exemplary relation between the hashes (e.g. H1-H8) (which are stored in a separate deduplication table) and two separate data objects D1 and D2 are shown. Portions within blocks B1-B4 of file D1 are shown with hashes H1-H4, and portions within blocks B1, B2, B4, B7, and B8 of file D2 are shown with hashes H1, H2, H4, H6, H7, and H8 respectively. It is noted that portions of data objects having the same hash value are only stored in memory once with its location of storage within memory recorded in the deduplication table along with the hash value.

Referring to FIG. 11, a table 1100 is shown with filenames (“Filename 1”-“Filename N”) of the files stored in the file table along with their data objects for the files' network location addresses. Exemplary data objects of Filename 1 are stored at network location address 1-5. Exemplary data objects of Filename 2 are stored at location address 6, 7, 3, 4, 8 and 9. The data objects of “Filename 2” are stored at location address 3 and 4 are shared with “Filename 1”. “Filename 3” is a clone of “Filename 1” sharing the data objects at location addresses 1, 2, 3, 4 & 5. “Filename N” shares data objects with “Filename 1” and “Filename 2” at location addresses 7, 3 and 9.

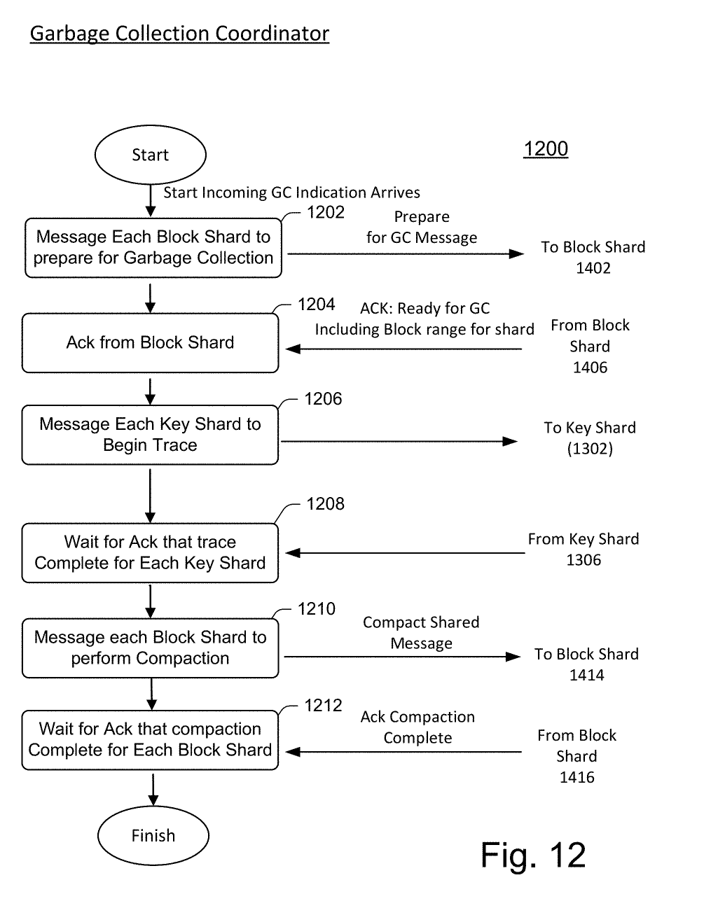

Illustrated in FIG. 12, is exemplary process 1200 implemented by servers 309a-309n (See FIG. 3a) and garbage collection coordinator module 438 (FIG. 4) for deduplicating storage and garbage collection across a network. Garbage collection coordinator module 438 in one of servers 309a-309n is nominated to orchestrate the garbage collection process by whichever server the load balancer happened to forward the ‘start garbage collection’ request. This will be abbreviated to “GC Coordinator” in the following text and in FIGS. 12 to 15. Such exemplary process 1200 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process is described with reference to FIG. 3a, although it may be implemented in other system architectures.

Each key shard is allocated to a specific server from 309a to 309n, known as the key shard server for that shard. Each block shard is allocated to a specific server from 309a to 309n, known as the block shard server for that shard. To keep the descriptions in the following text concise we refer to sending a message ‘to a block shard’ or ‘to a key shard’. In each case the message is actually sent to the key shard server or block shard server (309a-309n) for that shard, and then the message is internally routed to the key shard component or block shard component for the shard within that server. A reference map is a data structure used to record a set of references to specific block locations, to determine which blocks are ‘in-use’, versus those able to be deleted. A variety of data structures can be used to implement the reference map.

The GC coordinator sends a message to each key shard to begin a trace operation for that key shard. Each request will include the block range information for every block shard. The trace operation will find all references to blocks that should prevent those blocks from being deleted, across all block shards.

Specifically, in block 1202, an incoming request to Start Garbage Collection arrives into the scale-out cluster, via the Load Balancer. In block 1202 each block shard (in servers 309a-309n) is messaged to prepare for garbage collection (see 1402).

In block 1204 the GC coordinator waits for an ‘acknowledge ready for garbage collection’ message to be received from each block shard (see 1406). This message will include a block range for the shard.

In block 1206, each key shard (in servers 309a-309n) is sent a message to begin a trace (see 1302) and in block 1208, the coordinator waits for an acknowledgement from each key shard that the trace is complete (see 1306).

In block 1210, the coordinator sends a message to each block shard to perform compaction (see 1414).

In block 1212, the coordinator waits for an acknowledgement from each block shard that compaction has been complete (see 1416).

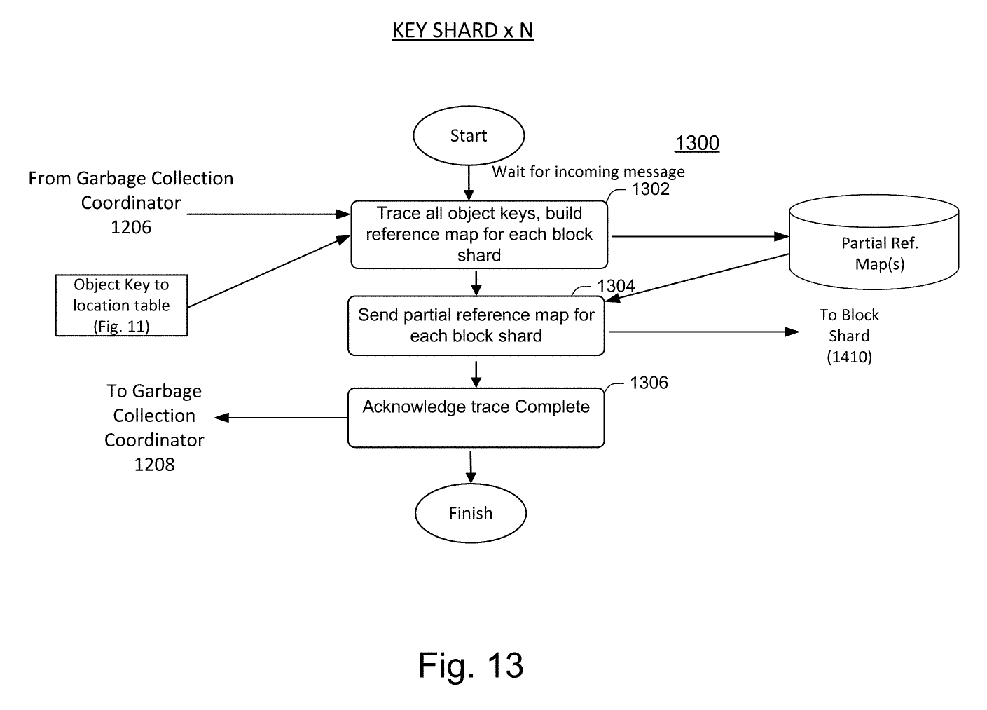

Illustrated in FIG. 13, is exemplary process 1300 implemented by key shard modules in servers 309a-309n (FIG. 3a) for performing a trace operation during a garbage collection process across a network. Such exemplary process 1300 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process is described with reference to FIG. 3a, although it may be implemented in other system architectures.

The key shard server performs the following trace process:
a) A partial reference map is created for each block shard, to record the references found. The location of each block that is referenced (i.e. still used) as part of a file is recorded in the reference map. The aim is to find blocks that are no longer referenced so they can be deleted. The key shard server traces through every entry in the object-key-to-location table for every shard, and collect up all the references. The references can be compared with the list of blocks being managed to find blocks that are no longer needed (because the files that used to reference them have been removed).
b) The key shard iterates through the object-key-to-location table for all the objects it manages, recording each reference to a block in the appropriate partial reference map.
c) After a key shard has finished recording references, each partial reference map is sent to its corresponding block shard server.
d) After all reference maps have been sent, the key shard server responds to the GC coordinator, acknowledging that the trace operation is complete for that key shard.

Specifically, in block 1302, after waiting for an incoming message from garbage collection coordinator (see 1206) to start process 1300, all object keys in this key shard are traced and a reference map for each block shard is built using the object-key-to-location table (See FIG. 11) and stored in a partial reference map.

In block 1304, the key shard reads the partial reference map for each block shard and sends each partial reference map to the corresponding block shard (see 1410).

In block 1306, an acknowledgement that the trace is complete is sent to the garbage collection coordinator (see 1208). Once all trace operations have been completed, the Garbage Collection coordinator can begin compaction operations.

Illustrated in FIG. 14, is exemplary process 1400 implemented by block shard modules in servers 309a-309n (FIG. 3a) for performing a compaction operation during a garbage collection process across a network. Such exemplary process 1400 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process is described with reference to FIG. 3a, although it may be implemented in other system architectures.

For each block shard, the corresponding block shard server performs the following process:
A) The current maximum block location for the shard is recorded. This defines the block location range for this shard, which is the set of block locations that will be covered by this GC operation.
B) An empty reference map is created covering the block range. The partial reference maps produced during the trace operation will be merged into this reference map.
C) The block shard server responds to the GC coordinator, acknowledging that it is now ready for GC and providing information about the block range covered by this GC operation.

For each block shard, the block shard server will receive partial reference maps from each key server containing the results of that key server's trace operation. Each incoming partial reference map is merged with the existing reference map for the block shard, contributing more references to blocks. Once the partial reference maps from all key shard servers have been received and merged, the resulting map will contain an exhaustive list of references to blocks in this block shard (within the block location range).

Specifically, in block 1402, the block shard module waits for an incoming message from the GC Coordinator and defines a block location range for this garbage collection run, referencing the hash-to-location table.

In block 1404, the block shard module creates an empty reference map in the reference map table, and in block 1406 the block shard module sends an acknowledgement to the GC Coordinator.

In block 1408, the block shard module waits for incoming partial reference maps from each key shard (see 1304), and then, in block 1410, merges each incoming partial reference map into the existing reference map for the shard. Where the reference maps are implemented using a bitmap, the merge operation is implemented by performing a bitwise OR operation on each corresponding bit in the two bitmaps to merge the two sets of references.

In block 1412 a determination is made whether an incoming partial reference map has been received from all key shards. If it has not, then blocks 1408-1410 are repeated. If all incoming reference maps have been received, and a ‘begin compaction’ message has been received from the GC Coordinator (see 1210), data compaction is performed in the cloud object store in block 1414 (See FIG. 15 for more detail).

After the data is compacted in the cloud object store, in block 1416 an acknowledgement is transmitted to the GC Coordinator (see 1212).

Illustrated in FIG. 15, is exemplary process 1500 implemented by block shard modules in servers 309a-309n (FIG. 3a) for compacting data in the Cloud Object Store during a compaction operation, specifically for block 1414 (FIG. 14) of the garbage collection process. Such exemplary process 1500 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process is described with reference to FIG. 3a and FIG. 14, although it may be implemented in other system architectures.

For each block shard, the block shard server performs the following compaction process: The block shard server iterates through each back-end object in the Cloud Object Store managed by the shard. Each back-end object can contain one or more blocks of data, and therefore can span multiple locations within the block shard.

Each back-end object may be compacted using the following process:
a. The reference map is examined to determine which of the locations within the back-end object are referenced, and which locations are no longer referenced.
b. The back-end object is altered in the Cloud Object Store to remove the block data from locations which are no longer referenced. Only block data which is still referenced will remain.
c. The hash-to-location table is updated to remove the entries for blocks that have been removed during the compaction process.
d. After each back-end object in the Cloud Object Store for this shard has been compacted, the reference map for the block shard can be deleted.
e. The block shard server responds to the GC coordinator acknowledging that the compaction operation is completed for this block shard.

Specifically in block 1502, after waiting for an incoming message to compact the shard from the GC Coordinator (see 1210), the back-end objects to compact are determined using the hash-to-location table.

In block 1504, a determination is made as to which blocks in the back-end object are still referenced using information from the hash-to-location table and the reference map.

In block 1506, the back-end objects are modified or re-written into the cloud object store to remove unused blocks. Back end objects may be modified, or may be re-written by writing a new version of the object that replaces the old version. The new version of the object omits the data blocks which are no longer required.

For example, if a back-end object contains exemplary blocks 1, 2, 3, 4, 5 and 6, and the system determines that blocks 3 and 4 are no longer referenced and can be deleted, then the system will re-write the back-end object so that it contains only blocks 1, 2, 5 and 6. This changes the offset within the back-end object at which blocks 5 and 6 are stored; they are now closer to the start of the back-end object. The offset of blocks 1 and 2 does not change. The amount of storage required for the back-end object is reduced because it no longer contains blocks 3 and 4.

Each location is an offset within a particular back-end object. (For example, shard 5, object number 1,234,567, offset 20,000 bytes from the start of the object). In one implementation this is the location where the bytes making up the data block are stored within the object store.

In block 1508, the hash-to-location table is updated to remove entries for blocks which have been removed from the Cloud Object Store.

In block 1512, a determination is made as to whether more backend objects exist within the block location range for this compact data process. If there are more backend objects, block 1504-block 1508 are repeated. If there are no more objects, then this process completes.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A method to perform garbage collection to compact data in a memory of one or more multiple network capable servers comprising:
storing one or more backend objects in an object store;
creating data in a reference map of the of the object store to indicate which locations within the one or more back-end objects in the object store are currently referenced by an object-key-to-location table, and which locations within the one or more back-end objects are no longer referenced;
altering the one or more back-end objects in the object store to remove block data from the locations within the one or more back-end objects which are no longer referenced; and
updating a hash-to-location table to remove entries in the table corresponding to block data that have been removed.

2. The method as recited in claim 1, further comprising referencing the locations within the back-end object in the object store using the hash-to location table.

3. The method as recited in claim 1, further comprising identifying which locations within the back-end object in an object store are currently referenced, and which locations are no longer referenced by running a trace process that determines which locations within the back-end object contain data that is still currently referenced.

4. The method as recited in claim 3 wherein the trace process includes:
creating a partial reference map for each block shard, to record the references found;
iterating within each key shard through the object-key-to-location table for objects managed by the key shard and recording a reference in the partial reference map for each block location that appears in the object-key-to-location table; and
sending the partial reference map to a corresponding block shard server.

5. The method as recited in claim 1, further comprising:
deleting the reference map after it has been used to update the hash-to-location table to remove all entries in the table that correspond to block data that have been removed from the object store.

6. The method as recited in claim 4 further comprising,
collecting with the block shard server the reference maps from every key shard, and
removing with the block shard server blocks that are no longer referenced.

7. A system to perform garbage collection to compact data, the system comprising:
an object store storing a backend object;
one or more multiple network capable servers including a memory;
a reference map created in the memory to indicate which locations within a back-end object stored in the object store are currently referenced, and which locations within the back-end object stored in the object store are no longer referenced;
circuitry to alter the back-end object stored in the object store to remove block data from the locations within the back-end object stored in the object store which are no longer referenced; and
circuitry to remove entries within a hash-to-location table identifying locations of block data within the back-end object that have been removed.

8. The system as recited in claim 7, further comprising:
circuitry to delete the reference map after removal of all entries in the hash-to-location table corresponding to block data that have been removed.

9. The system as recited in claim 7, further comprising:
circuitry to run a trace process that identifies which locations within the back-end object contain data that is still currently referenced, and which locations are no longer referenced.

10. The system as recited in claim 9, wherein the circuitry to run the trace process includes:
circuitry to create a partial reference map for each block shard, to record the references found;
circuitry to iterate with a key shard through the object-key-to-location table for objects managed by the key shard and recording a reference in the partial reference map for each block location that appears in the object-key-to-location table; and
circuitry to send the partial reference map to a corresponding block shard server.

11. An apparatus, comprising:
at least one non-transitory medium for execution by a processor in a server, the at least one non-transitory medium includes at least:
one or more instructions for creating data in a reference map of the memory to indicate which locations within a back-end object in an object store are currently referenced, and which locations are no longer referenced;
one or more instructions for altering the back-end object in the object store to remove block data from the locations which are no longer referenced; and
one or more instructions for updating a hash-to-location table identifying locations of block data within the back-end object to remove entries in the table identifying locations of block data that have been removed.

12. The apparatus as recited in claim 11, wherein the at least one non-transitory medium includes at least:
instructions for referencing the locations within the back-end object in the object store using the hash-to location table.

13. The apparatus as recited in claim 12, wherein the at least one non-transitory medium includes at least:
instructions for identifying which locations within the back-end object in an object store are currently referenced, and which locations are no longer referenced by running trace process instructions to determine which locations within the back-end object contain data that is still currently referenced.

14. The apparatus as recited in claim 12, wherein the trace process instructions includes:
instructions for creating a partial reference map for each block shard, to record the references found;
instructions for iterating with a key shard through the object-key-to-location table for objects managed by the key shard and recording a reference in the partial reference map for each block location that appears in the object-key-to-location table; and
instructions for sending the partial reference map to a corresponding block shard server.

15. The apparatus as recited in claim 11, wherein the at least one non-transitory medium includes at least:
instructions for deleting the reference map in response to updating the hash-to-location table to remove all entries in the table corresponding to block data that have been removed.
